(19) United States
(12) Patent Application Publication
(10) Pub. No.: US 2011/0087425 A1
(43) Pub. Date: Apr. 14, 2011

(54) NAVIGATION SYSTEM WITH MAP COMPRESSION AND METHOD OF OPERATION THEREOF

(75) Inventors: Kan Deng, Beijing (CN); Yueyu Lin, San Jose, CA (US); Yanyan Qin, Beijing (CN)

(73) Assignee: TELENAV, INC., Sunnyvale, CA (US)

(21) Appl. No.: 12/576,185

(22) Filed: Oct. 8, 2009

(51) Int. Cl. G01C 21/36

(52) U.S. Cl. 701/200

(57) ABSTRACT

A method of operation of a navigation system includes: preconstructing a multi-layered index based on a plurality of a spatially-aware identification for identifying location data points; selecting a first intersection based on the multi-layered index of the spatially-aware identification; and generating a primary route based on the first intersection for displaying on a device.

### TECHNICAL FIELD

The present invention relates generally to a navigation system, and more particularly to a navigation system with map compression.

### BACKGROUND ART

Modern portable consumer and industrial electronics provide increasing levels of functionality to support modern life including location-based information services. This is especially true for client devices such as navigation systems, cellular phones, portable digital assistants, and multifunction devices.

As users adopt mobile location based service devices, new and old usage begin to take advantage of this new device space. There are many solutions to take advantage of this new device opportunity. One existing approach is to use location information to provide navigation services, such as a global positioning service (GPS) navigation system for a mobile device. Systems can display map information, navigate and display a route between two points, and enable other services on these devices.

In response to consumer demand, navigation systems are providing ever-increasing amounts of information requiring these systems to handle more and more data in a limited amount of time. This information includes map data, business data, local weather, and local driving conditions. Increasing amounts of data are required to enable these services. However, the distributed nature of many systems can give rise to challenges for the users of these systems. For example, systems may be required to relay large amounts of data across a system with limited bandwidth. Also, the available storage on a device may compromise its ability to store large blocks of data, such as map data for a large area, or map data with a fine degree of detail.

Thus, a need remains for a navigation system that can efficiently transmit large amounts of data, or can efficiently store substantial blocks of data for use by the system. In view of the ever-increasing commercial competitive pressures, along with growing consumer expectations and the diminishing opportunities for meaningful product differentiation in the marketplace, it is critical that answers be found for these problems. Additionally, the need to reduce costs, improve efficiencies and performance, and meet competitive pressures adds an even greater urgency to the critical necessity for finding answers to these problems.

Solutions to these problems have been long sought but prior developments have not taught or suggested any solutions and, thus, solutions to these problems have long eluded those skilled in the art.

### DISCLOSURE OF THE INVENTION

The present invention provides a method of operation of a navigation system including: preconstructing a multi-layered index based on a plurality of a spatially-aware identification for identifying location data points; selecting a first intersection based on the multi-layered index of the spatially-aware identification; and generating a primary route based on the first intersection for displaying on a device.

The present invention provides a navigation system including: a preconstruction module for preconstructing a multi-layered index based on a plurality of a spatially-aware identification for identifying location data points; a segment selection module for selecting a first intersection based on the multi-layered index of the spatially-aware identification; and a navigation guidance module of a control unit for generating a primary route based on the first intersection for displaying on a device, the control unit coupled to a user interface.

Certain embodiments of the invention have other aspects in addition to or in place of those mentioned above. The aspects can become apparent to those skilled in the art from a reading of the following detailed description when taken with reference to the accompanying drawings.

### BRIEF DESCRIPTION OF THE DRAWINGS

FIG. 1 is an example of an environment using an embodiment of the present invention.

FIG. 2 is an illustration of an example application of a navigation system with map compression in a first embodiment of the present invention.

FIG. 3 is a quad-tree view of a spatially-aware identification.

FIG. 4 is an illustration of a multi-layered index.

FIG. 5 is an illustration of a topology data record.

FIG. 6 is an illustration of an intersection relative location for a location of an intersection point in a leaf.

FIG. 7 is an illustration of an edge relative location.

FIGS. 8A and 8B are various views of an example of a restriction.

FIG. 9 is an illustration of a shape data record for map rendering.

FIG. 10 is a flow chart of a map data compression flow.

FIG. 11 is a flow chart of a route generation flow.

FIG. 12 is a flow chart of a shape selection for map rendering.

FIG. 13 is a block diagram of a navigation system with map compression in a second embodiment of the present invention.

FIG. 14 is a block diagram of a navigation system with map compression in a third embodiment of the present invention.

FIG. 15 is a flow chart of a method of operation of the navigation system with map compression in a further embodiment of the present invention.

### BEST MODE FOR CARRYING OUT THE INVENTION

The following embodiments are described in sufficient detail to enable those skilled in the art to make and use the invention. It is to be understood that other embodiments would be evident based on the present disclosure, and that system, process, or mechanical changes can be made without departing from the scope of the present invention.

In the following description, numerous specific details are given to provide a thorough understanding of the invention. However, it can be apparent that the invention can be practiced without these specific details. In order to avoid obscuring the present invention, some well-known circuits, system configurations, and process locations are not disclosed in detail.

The drawings showing embodiments of the system are semi-diagrammatic and not to scale and, particularly, some of the dimensions are for the clarity of presentation and are shown exaggerated in the drawing FIGs. Similarly, although the views in the drawings for ease of description generally show similar orientations, this depiction in the FIGs. is arbitrary for the most part. Generally, the invention can be operated in any orientation.

The same numbers are used in all the drawing FIGs. to relate to the same elements. The embodiments have been numbered first embodiment, second embodiment, etc. as a matter of descriptive convenience and are not intended to have any other significance or provide limitations for the present invention.

One skilled in the art would appreciate that the format with which navigation information is expressed is not critical to some embodiments of the invention. For example, in some embodiments, navigation information is presented in the format of (x, y), where x and y are two ordinates that define the geographic location, i.e., a position of a user.

The navigation information is presented by longitude and latitude related information. The navigation information also includes a velocity element comprising a speed component and a direction component.

The term “navigation routing information” referred to herein is defined as the routing information described as well as information relating to points of interest to the user, such as local businesses, hours of business, types of business, advertised specials, traffic information, maps, local events, and nearby community or personal information.

The term “module” referred to herein can include software, hardware, or a combination thereof. For example, the software can be machine code, firmware, embedded code, and application software. Also for example, the hardware can be circuitry, processor, computer, integrated circuit, integrated circuit cores, or a combination thereof.

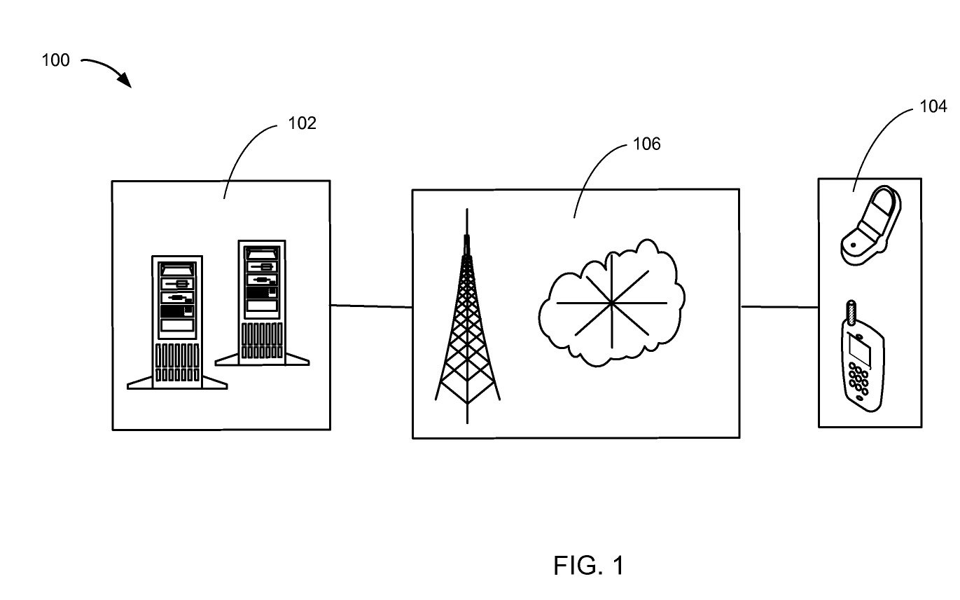

Referring now to FIG. 1, therein is shown an example of an environment 100 using an embodiment of the present invention. The environment 100 applies to any embodiment of the present invention described later. The environment 100 includes a first device 102, such as a server or client. The first device 102 can be linked to a second device 104, such as a client or server, with a communication path 106, such as a network.

The first device 102 can be any of a variety of centralized or decentralized computing devices. For example, the first device 102 can be a computer, a computer in a grid computing pool, a virtualized computer, a computer in a cloud computing pool, or a computer in a distributed computing topology. The first device 102 can include routing functions or switching functions for coupling with the communication path 106 to communicate with the second device 104.

The second device 104 can be of any of a variety of mobile devices. For example, the second device 104 can be a cellular phone, personal digital assistant, a notebook computer, or other multi-functional mobile communication or entertainment devices having means for coupling to the communication path 106.

The communication path 106 can be a variety of networks. For example, the communication path 106 can include wireless communication, wired communication, optical, ultrasonic, or a combination thereof Satellite communication, cellular communication, Bluetooth, Infrared Data Association standard (IrDA), wireless fidelity (WiFi), and worldwide interoperability for microwave access (WiMAX) are examples of wireless communication that can be included in the communication path 106. Ethernet, digital subscriber line (DSL), fiber to the home (FTTH), and plain old telephone service (POTS) are examples of wired communication that can be included in the communication path 106.

Further, the communication path 106 can traverse a number of network topologies and distances. For example, the communication path 106 can include personal area network (PAN), local area network (LAN), metropolitan area network (MAN), and wide area network (WAN).

For illustrative purposes, the first device 102 is shown in a single location, although it is understood that the server can be centralized or decentralized and located at different locations. For example, the first device 102 can represent real or virtual servers in a single computer room, distributed across different rooms, distributed across different geographical locations, embedded within a telecommunications network, virtualized servers within one or more other computer systems including grid or cloud type computing resources, or in a high powered client device.

Further for illustrative purposes, the environment 100 is shown with the second device 104 as a mobile computing device, although it is understood that the second device 104 can be different types of computing devices. For example, the second device 104 can be a mobile computing device, such as notebook computer, another client device, or a different type of client device.

Yet further for illustrative purposes, the environment 100 is shown with the first device 102 and the second device 104 as end points of the communication path 106, although it is understood that the environment 100 can have a different partition between the first device 102, the second device 104, and the communication path 106. For example, the first device 102, the second device 104, or a combination thereof can also function as part of the communication path 106.

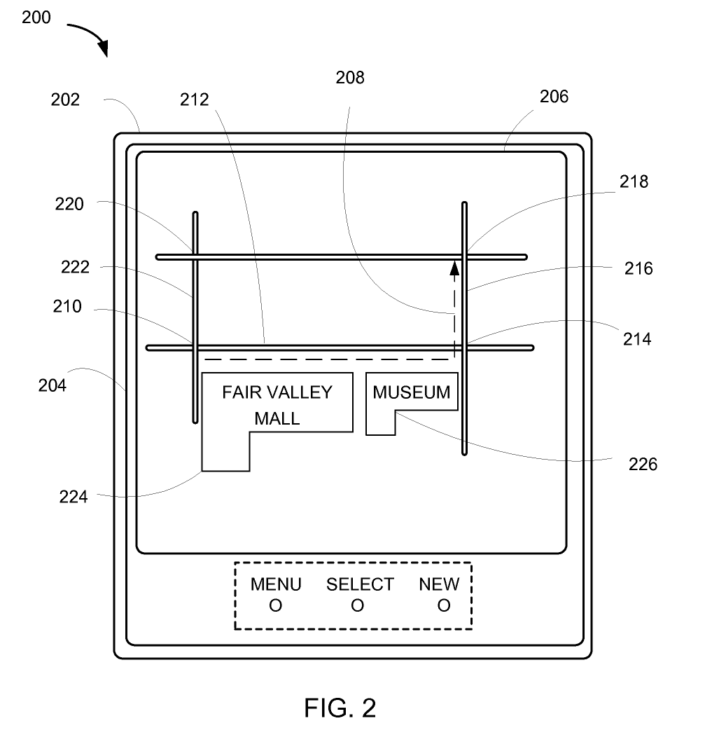

Referring now to FIG. 2, therein is shown an example application of a navigation system 200 with map compression in a first embodiment of the present invention. The navigation system 200 is shown operating on a device 202 with a user interface 204. The device 202 can be a mobile computing device such as the second device 104 of FIG. 1. The user interface 204 can include an input device and an output device. For example, the output device can include a display 206, a projector, a video screen, a speaker, or any combination thereof. Examples of the input device include a keypad, a touchpad, soft-keys, a keyboard, a microphone, or any combination thereof to provide data and communication inputs.

The illustration shows a region of a street map on the display 206 of the device 202 with the navigation system 200. The display 206 shows a primary route 208. For clarity, the primary route 208 is shown as a dotted arrow. The primary route 208 can originate at a first intersection 210, can follow a first road segment 212 to a second intersection 214, and can follow a second road segment 216 culminating at a third intersection 218.

A fourth intersection 220 is also included in the illustration. The fourth intersection 220 is shown connected to the first intersection 210 by a third road segment 222, which is not part of the primary route 208.

The navigation system 200 can generate the primary route 208 by selecting road segments and intersections from map data, or other data source. The navigation system 200 can select the road segments and intersections in a sequence to provide the navigation routing information from the first intersection 210 to the third intersection 218. The map data can include information about intersections, road segments, features and other information relevant to the functions of navigation information systems.

The user interface 204 can also display shapes, such as a first feature 224 and a second feature 226. The navigation system 200 can retrieve and display shapes such as shopping malls, streets, parks, administrative areas, points of interest (POI) and other shapes pertinent to displaying mapping or navigation information. In this example, the first feature 224 can be a shopping mall close to the primary route 208 generated by the navigation system 200. The navigation system 200 can display the first feature 224 alongside the primary route 208. The navigation system 200 can also display the second feature 226, which can be a museum, and which is also close to the primary route 208.

Other features and shapes can be included with the data source. The navigation system 200 can display features and shapes based on the location and other information associated with the features and shapes in the map data.

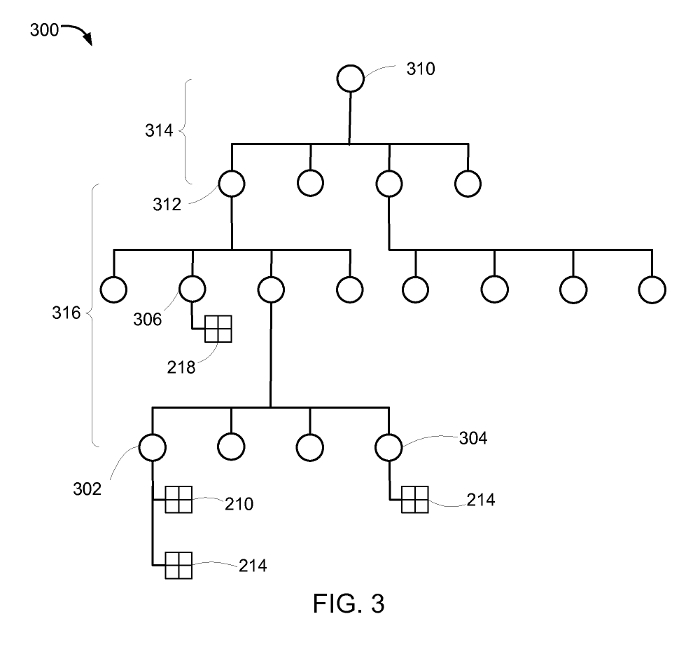

Referring now to FIG. 3, therein is shown a quad-tree view of a spatially-aware identification 300. The navigation system 200 of FIG. 2 can preconstruct the spatially-aware identification 300 for information such as map data. The spatially-aware identification 300 is a reference to a data point based on the position of the data point relative to other data points. The spatially-aware identification 300 can include a string of characters, for example, which can uniquely identify a data point, such as a location, an intersection, or a feature. The identification is spatially aware, such that the spatially-aware identification 300 of a data point of the map data can be associated with its geographic location.

The position of nodes and data points in the quad-tree view of the spatially-aware identification 300 can reflect the proximity of the geographic location of the nodes or data points. The spatially-aware identification 300 of map data can be used by the navigation system 200 for providing navigation routing information.

The data points of the map data can represent a physical location, such as an intersection of road segments, a shape point on a street, an address, a point of interest (POI) or other entity with relevance to navigation. The data points are included in nodes, which can be a collection of other nodes or data points. The data points can include data which the navigation system 200 can operate on to generate navigation routing information. For illustrative purposes, the quad-tree is shown with nodes represented by circles, and data points represented by squares with an internal cross.

The illustration shows data points of the map data, such as the first intersection 210 and the second intersection 214, both of which are included in a node such as the first leaf 302. The third intersection 218 is included in a second leaf 304, which is a different node. The fourth intersection 220 is included in a third leaf 306, which is a yet different node of the quad-tree. The first intersection 210 and the second intersection 214 can be geographically close together, and this can be reflected by their close proximity in the quad-tree. The third intersection 218 in the second leaf 304 can reflect that the third intersection 218 can be at a further distance from the first intersection 210. The fourth intersection 220 in the third leaf 306 can reflect a yet further distance from the first intersection 210 and the second intersection 214.

The navigation system 200 can generate the spatially-aware identification 300 for each node and data point of the map data, starting with a root such as a map root 310. The map root 310 can be a common point of origin for all information included with the map data. The quad-tree can be arranged by recursively dividing the information into four quadrants in successive layers. Each node can be further divided until each node can meet a criterion, such as observing a maximum number of data points. A node which contains only data points or intersections can be referred to as a leaf For example, the first leaf 302 can be a node which can include the first intersection 210 and the second intersection 214.

As an example of the criterion for a leaf, the navigation system 200 can have a limit on the number of data points in a leaf, such as a maximum of two hundred fifty-six data points in any leaf. A node which includes more than two hundred fifty-six data points can be further subdivided into quadrants by the navigation system 200 until the limit of two hundred fifty-six data points in a leaf can be observed. The selection of a maximum of two hundred fifty-six data points can be relevant for a system with binary notation, as two hundred fifty-six data points can be addressed by one byte of eight bits.

As an example, map data of the forty-eight contiguous states of the USA can be divided into a thirteen-layer tree structure, in which the leaves include a maximum of two hundred fifty-six data points. For convenience to describe the present invention, FIG. 3 is shown with four layers of nodes, although it is understood that a different number of layers can be used to describe different geographic regions.

FIG. 3 also includes a first internal node 312, which is an internal node of the quad-tree view of the spatially-aware identification 300. The navigation system 200 can generate the spatially-aware identification 300 with internal nodes, which can be used for the purpose of eliminating redundancies from the spatially-aware identification 300 of one data point relative to another data point.

The identification scheme of the spatially-aware identification 300 can be based on the position of a data point in the quad-tree view of the spatially-aware identification 300, and can be expressed as a path from the map root 310 to any node or data point. For example, the map root 310 in the first layer can be divided into four nodes in a second layer, which can be identified in binary notation as 00, 01, 10, and 11 in a predetermined geographic order. Each node of the second layer can be further subdivided into four nodes in a third layer, and a node of the third layer can have an identifier based on its second-level root identifier. For example, the first internal node 312 in the second layer can be identified as 00, and the third leaf 306 can be identified as 0001. Because the map data is divided into geographic quadrants, the identification for any node can be unique and spatially-aware.

A path to or from an internal node can be referred to as a partial path. In the spatially-aware identification 300, the partial path from the map root 310 to an internal node can be referred to as a block identification. For example, the partial path from the map root 310 to the first internal node 312 can be a first block identification 314 with a value of 00. Nodes or data points in the sub-tree under the first internal node 312 can share the first internal node 312 as a common sub-root, and can share the first block identification 314 as a common block identification. For example, the first intersection 210, the second intersection 214, and the third intersection 218, can all share the first block identification 314 as their block identification.

There can be a partial path from an internal node to a leaf. For example, the partial path from the first internal node 312 to the first leaf 302 can be referred to as a relative leaf identification, such as the first relative leaf identification 316. The relative leaf identification will be discussed in more detail.

Each data point in a leaf can have a sequential identification, which is a unique identifier of the data point to distinguish it from other data points in the same leaf. The data points or intersections can be organized in a leaf according to geographic location. For example, the data points and intersections of the first leaf 302, such as the first intersection 210 and the second intersection 214, can be ordered according to their location in the leaf. The sequential identifier for the intersections can be assigned in order beginning with the left-most intersection. For map data, this ordering can begin with the western-most intersection, progressing across all data points of the first leaf 302.

It has been discovered that the spatially-aware identification 300 can provide a reference to a data point of a navigation location with relevance to other data points in relative proximity. The spatially-aware identification 300 of locations close to each other can be very similar, which enables efficient storage and recall of nearby locations, as well as simplified traversal to a data point from a nearby data point.

The physical transformation of the spatially-aware identification 300 results in movement in the physical world, such as people using vehicles, based on the operation of the navigation system 200. As the movement in the physical world occurs, the movement itself creates additional information that is converted back to the spatially-aware identification 300 for the continued operation of the navigation system 200 and to continue the movement in the physical world.

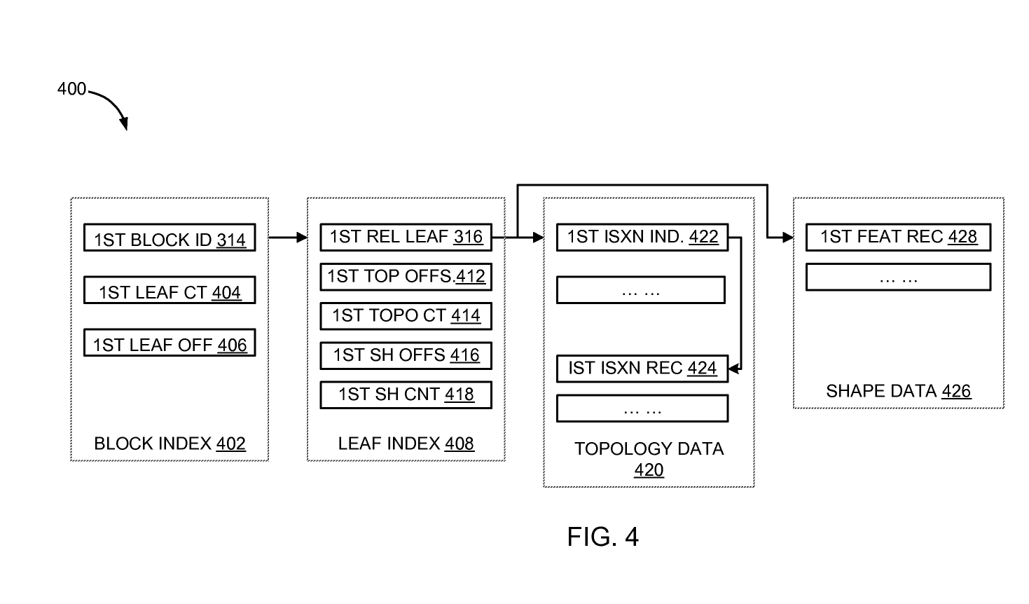

Referring now to FIG. 4, therein is shown an illustration of a multi-layered index 400. The multi-layered index 400 can provide an indexing capability for the spatially-aware identification 300 of FIG. 3 for limiting the length of the spatially-aware identification 300 without loss of information. The navigation system 200 of FIG. 2 can preconstruct the multi-layered index 400 based on the spatially-aware identification 300 of FIG. 3 for the purpose of organizing information included with data such as map data. Data points can have a unique instance of the spatially-aware identification 300, and the multi-layered index 400 can organize the spatially-aware identification 300 of the data points.

The multi-layered index can include a block index 402. The block index 402 can include indexing information associated with an internal node such as the first internal node 312 of FIG. 3. The block index 402 can include a block identification such as the first block identification 314. The block identification can be a partial path from the map root 310 of FIG. 3 to an internal node, such as the first internal node 312 of FIG. 3.

The block index 402 can also include a leaf count associated with a block identification. For example, a first leaf count 404 can be the number of leaves, which have the first internal node 312 as a common sub-root. The leaf count can indicate to the navigation system 200 how many leaves are in a sub-tree, and the navigation system 200 can use this information when traversing the spatially-aware identification 300 for information related to a sub-tree of an internal node.

The block index 402 can also include a leaf offset associated with each block identification of the block index 402. For example, a first leaf offset 406 can be an offset associated with the first block identification 314 of the first internal node 312. The first leaf offset 406 can indicate the start of the information associated with leaves of the sub-tree of the first internal node 312. The navigation system 200 can preconstruct the spatially-aware identification 300 such that the information for leaves within a sub-root can be contiguous. Having the leaves under an internal node arranged contiguously, and knowing the number leaves under an internal node, can enable the navigation system 200 to traverse the multi-layered index 400 and the spatially-aware identification 300 efficiently.

For the purpose of clarity, FIG. 4 shows the block index 402 with information for the first internal node 312 only. However, it is understood that the block index 402 can include information for other internal nodes of the spatially-aware identification 300 of FIG. 3. For example, there can be more than one block identification in the block index 402, with a leaf count and a leaf offset associated with each block identification.

The multi-layered index 400 can include also include a leaf index 408. The leaf index 408 can include information relating to the arrangement of information of an individual leaf associated with an internal node. For example, the first leaf offset 406 can indicate information in the leaf index 408 associated with the first internal node 312. The leaf index 408 can include a relative leaf identification, such as the first relative leaf identification 316. The first relative leaf identification 316 can be a partial path from the first internal node 312 to the first leaf 302 of FIG. 3. The combination of the first block identification 314 and the first relative leaf identification 316 can represent the unique identification of the first leaf 302.

The leaf index 408 can also include a topology offset, such as a first topology offset 412, and a topology count such as the first topology count 414. The topology count can be a count of the number of data points, each with a topology record, associated with a leaf. For example, the first topology count 414 can be the number of data points associated with the first leaf 302. A topology offset, such as the first topology offset 412 can be an offset to the start of the topology information associated with the first leaf 302.

The term topology can refer to information used by the navigation system 200 for generating navigation routing information. For example, topology information can include data for thoroughfares, intersections, and other information which can be used by the navigation system for the generation of navigation routing information and navigation guidance.

The leaf index 408 can also include a shape offset such as a first shape offset 416, and a shape count such as a first shape count 418. A shape offset can point to the beginning of a storage space where shape information associated with a leaf can be stored contiguously. For example, the first shape offset 416 can point to the information associated with shapes in the first leaf 302. A shape count can be a count of the number of shapes associated with a leaf. For example, the first shape count 418 can be the number of shapes associated with the first leaf 302.

Shape information can be related to physical shapes of entities, for example, map data which includes parks, rivers, hills and other. Shape information can be used by the navigation system 200 when presenting navigation routing information on a display. As an example, the first feature 224 of FIG. 2 and the second feature 226 of FIG. 2 can be shapes or features located near the primary route 208 of FIG. 2.

For the purpose of clarity, FIG. 4 shows the leaf index 408 with indexing information associated with one leaf, which is the first leaf 302. However, it is understood that the leaf index 408 can include information about other leaves associated with the first internal node 312 and other internal nodes.

The multi-layered index can also include topology information for data points in topology data 420. The topology data 420 of the navigation system 200 can be used by the navigation system 200 to generate navigation routing information, such as the primary route 208. The navigation system 200 can traverse the multi-layered index 400 of FIG. 4 with the tree structure of the spatially-aware identification 300 to select road segments for the purpose of generating the primary route 208 using data points of the topology data 420. Examples of data points in the topology data 420 can include roads and intersections. The navigation system can retrieve information from the topology data 420 to generate navigation routing information such as the primary route 208.

The topology data 420 of the spatially-aware identification 300 can include an intersection index such as a first intersection index 422, and a record of information for a data point such as a first intersection record 424. The first intersection index 422, can point to the storage space which includes the first intersection record 424. The first intersection record 424 can include the information associated with the first intersection 210 of FIG. 3, such as the location of the intersection and road segments connected to the first intersection 210. Such information can be used by the navigation system 200 to generate navigation routing information such as the primary route 208.

The first topology offset 412 of the leaf index 408 can point to the first intersection index 422 of the topology data 420. The first topology count 414 can be a count of the number of intersection points in the first leaf 302. This indexing can provide the navigation system 200 with the means to quickly locate topology information for generating navigation routing information.

The multi-layered index 400 can also include shape data 426. The shape data 426 can include information for shapes such as the first feature record 428. The shape data 426 can include a record for each shape counted in the shape count of the leaf index 408. For example, the first shape count 418 of the leaf index 408 can be the number of shapes in the shape data 426, which are associated with the first leaf 302.

The navigation system 200 can display the primary route 208 on the display of a device. The navigation system 200 can also display shapes of features on the display to enhance the display of the navigation routing information with the primary route 208.

It has been discovered that the navigation system 200 can reduce redundancy in the identification of nodes and leaves of the spatially-aware identification 300 and reduce the storage required for the map data. The physical transformation of the multi-layered index 400 results in movement in the physical world, such as people using vehicles, based on the operation of the navigation system 200. As the movement in the physical world occurs, the movement itself creates additional information that is converted back to the multi-layered index 400 for the continued operation of the navigation system 200 and to continue the movement in the physical world.

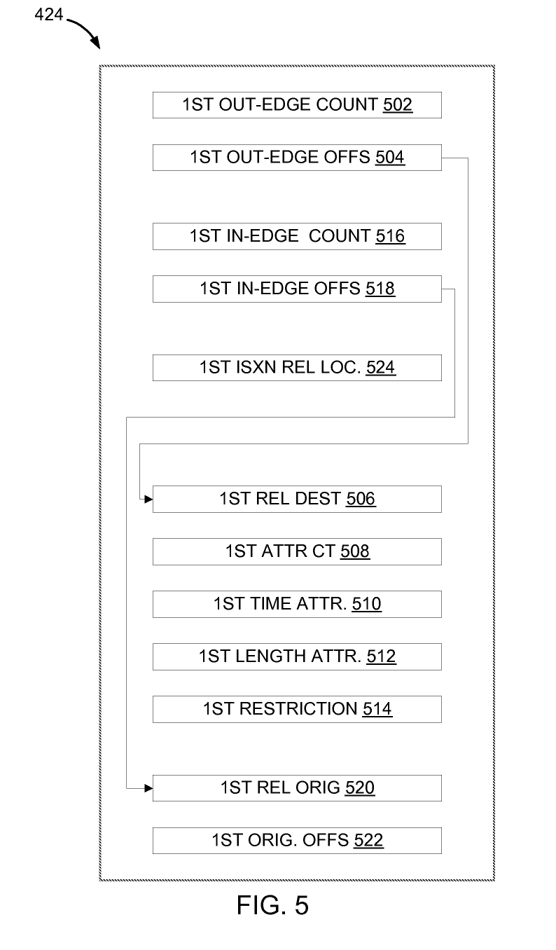

Referring now to FIG. 5, therein is shown an illustration of a topology data record. FIG. 5 shows a detail of the first intersection record 424 associated with the first intersection 210 of FIG. 2. The first intersection record 424 can include information about road segments or edges connecting to the first intersection, and the geographic location of the first intersection 210. Information such as the first intersection record 424 can be used for navigation routing applications of the navigation system 200 of FIG. 2.

A road segment can be described as a section of a navigable thoroughfare included with map data that can be selected as part of a route or other navigation routing information. A road segment can be described by the location of an intersection at each end of the road segment. For example, the first road segment 212 of FIG. 2 can be described with the location of the first intersection 210 of FIG. 2 and the second intersection 214 of FIG. 2. For the navigation system 200, an edge can be the same as a road segment.

For convenience to describe the navigation system 200 with map compression, the first intersection record 424 is shown with one outgoing edge and one incoming edge. However, it is understood that an intersection point can have any number of outgoing edges, and any number of incoming edges.

The first intersection record 424 can include a first out-edge count 502 and a first out-edge offset 504. An out-edge count, such as the first out-edge count 502, can be a count of the number of edges which originate at the first intersection 210. An out-edge offset, such as the first out-edge offset 504, can point to a storage location with information about an outgoing edge of an intersection.

Information about outgoing edges of the first intersection 210 can be stored in the first intersection record 424. For example, the first out-edge offset 504 can point to the start of the information associated with the first road segment 212, which is an outgoing edge of the first intersection 210. Data associated with other outgoing edges of the first intersection 210 can be stored contiguously in the first intersection record 424 after the information about the first road segment 212.

The first intersection record 424 can include a first relative destination 506. A relative destination can be an expression for the location of the destination of an outgoing edge relative to the location of the originating intersection. For example, the first relative destination 506 can be the location of the second intersection 214 relative to the location of the first intersection 210.

The first intersection record 424 can also include a first attribute count 508. An attribute count can be the number of attributes associated with an outgoing edge, which are included in an intersection record. For example, the first attribute count 508 can be a count of the number of attributes included with the first intersection record 424 associated with the first road segment 212. Having an attribute count in the record can indicate to the navigation system 200 how much information can be retrieved from an intersection record relating to a particular road segment.

The first intersection record 424 can also include a first time attribute 510. A time attribute can be an estimate of the time required for a device to travel from an intersection, along an outgoing edge, to a destination intersection. For example, the first time attribute 510 can be an estimated time required to travel from the first intersection 210 along the first road segment 212 to the second intersection 214. The time attribute can be used by the navigation system 200 to generate a navigable route with travel time as a priority.

The first intersection record 424 can also include a first length attribute 512. A length attribute can be an estimate of the distance from an intersection, along an outgoing edge, to a destination intersection. For example, the first length attribute 512 can be the distance from the first intersection 210 along the first road segment 212 to the second intersection 214. The length attribute can be used by the navigation system 200 to generate a navigable route with travel distance as a priority.

The first intersection record 424 can also include a first restriction 514. Examples of restrictions can include speed limits, parking limitations, limitations on turns etc. Restrictions can be full-time restrictions, or can apply at particular times. As an example, parking along an edge can be forbidden during the evening commute, or left-turns may be forbidden during weekdays.

The information associated with an outgoing edge of an intersection can include the relative destination, an attribute count, a time attribute, and length attribute, and a restriction. Outgoing edge information associated with an intersection can be stored with an intersection record.

The first intersection record 424 can also include a first in-edge count 516 and a first in-edge offset 518. An in-edge count, such as the first in-edge count 516 can be a count of the number of incoming edges to the first intersection 210. An in-edge offset, such as the first in-edge offset 518, can point to a storage location with information about an incoming edge of an intersection.

The first in-edge offset 518 can point to a first relative origin 520, which can be the location of an originating intersection of an incoming edge of the first intersection 210. An originating intersection, such as the first relative origin 520, can be the relative location of an intersection expressed relative to the location of the first intersection 210. As an example, the third road segment 222 of FIG. 2 can be an outgoing edge of the fourth intersection 220 of FIG. 2, and can be an incoming edge of the first intersection 210. The first relative origin 520 can be the location of the fourth intersection 220 relative to the location of the first intersection 210.

Information about incoming edges of the first intersection 210 can be stored contiguously in the first intersection record 424. For example, the first in-edge offset 518 can point to the start of the information associated with the third road segment 222. Data associated with other incoming edges of the first intersection 210 can be stored contiguously in the first intersection record 424 following the information about the third road segment 222.

The first in-edge offset 518 can point to the first relative origin 520, which can include the location of the fourth intersection 220 relative to the first intersection 210. The first origin offset 522 can be an offset which points to other information associated with the third road segment 222. The information for the third road segment 222 is stored with the intersection record for the fourth intersection 220. The first intersection record 424 points to the information of the third road segment 222 with the first origin offset.

The navigation system 200 with map compression can use offsets to avoid the redundancy of repeating the information associated with an intersection. These offsets significantly reduce the storage required to store information such as map data. The use of offsets to refer to information can enable the navigation system 200 to be more robust, as repeated use of the same information can include errors.

The first intersection record 424 can also include an intersection relative location, such as a first intersection relative location 524. As will be described in more detail, the navigation system 200 with map compression can calculate the intersection relative location of an intersection, which is its location relative to its position within a leaf. For example, the first intersection relative location 524 can be the location of the first intersection 210 relative to an origin point of the first leaf 302 of FIG. 3.

The number of characters required to express values can differ in map data. Higher levels of precision to express a numeric value can require more characters. The navigation system 200 with map compression can further reduce storage by using a “vint” to express some values which can have varying sizes. The vint is a dynamic encoding scheme used for the expression of some numeric values in the navigation system 200 with map compression. The vint can include an indicator to the navigation system 200 that can indicate whether the expression of the value is complete, or whether the value includes an additional word or set of words.

For example, street names can vary in length. A street name can encode the letters of the street name as a series of vints. All but the last letter can include an indicator that there is an additional letter in the street name. The last letter of the street name can have an indicator that there are no additional letters, and can mark the end of the street name in the record.

Some of the values in the first intersection record 424 can be expressed with a vint, such as the first intersection relative location 524, the first time attribute 510, and the first length attribute 512. The counts and offsets can have a common length, and can each be expressed without resorting to a vint. Restriction information such as the first restriction 514 can be a record, which can include a vint to express some values of the record.

It has been discovered that the use of vints can provide an efficient means of indicating the size of a record, such as a street name or other information associated with a navigation point. The indication of the record size can enable the navigation system 200 to more quickly and efficiently retrieve location information for the use of the functions and modules of the navigation system 200.

Records, such as the first intersection record 424, can be used for the purpose of navigation routing and turn guidance in the navigation system 200. Data, such as the first intersection record 424, can be grouped according to geographic location and proximity to connecting intersection points.

Data can also be grouped on different levels, such as the classification of thoroughfares. For example, one level of data can include records for highways, interstates, freeways etc., to emphasize highway hierarchy. Another level can include major municipal thoroughfares, such as expressways, and boulevards. A yet further level can include records for local roads such as municipal streets, residential areas.

An intersection record, such as the first intersection record 424 can include, point to, or otherwise indicate data and information concerning the intersection point, its location, and any incoming or outgoing edges associated with the intersection. This information can be retrieved by the navigation system 200 with map compression to generate navigation routing information, such as the primary route 208 of FIG. 2.

Map data provided by vendors of map data solutions can include significant amounts of repetitive information. For example, streets are described using lists of names which are often repeated. This can be especially true for long thoroughfares, which can have a large number of intersections. The street name of the long thoroughfare can be repeated multiple times in the map data and can therefore be a source of redundancy.

The navigation system 200 with map compression can generate an intersection record for each intersection, and can eliminate significant amounts of redundant or repeated information by generating offsets to a single instance of the information. Having a single instance of the information can also enhance reliability and limit errors due to multiple repetition of the same information.

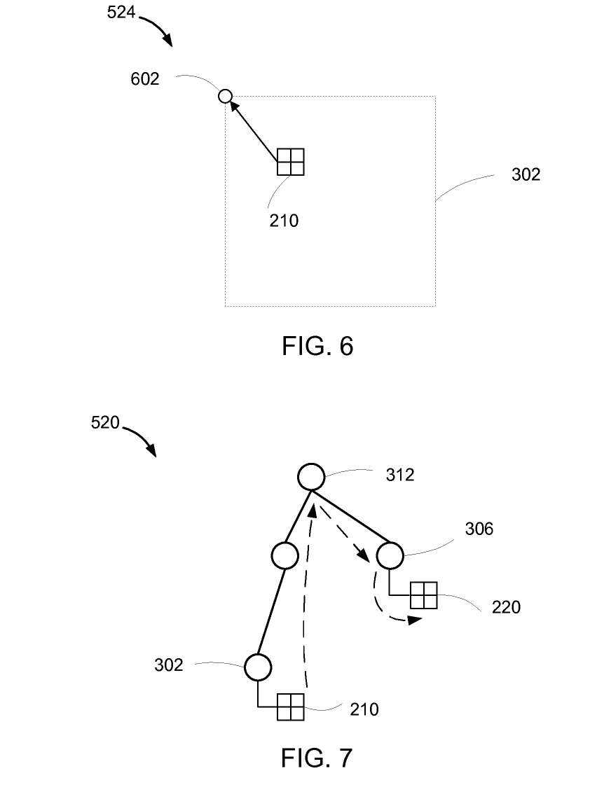

Referring now to FIG. 6, therein is shown an illustration of an intersection relative location for a location of an intersection point in a leaf. FIG. 6 illustrates how the first intersection relative location 524 can relate the location of the first intersection 210 to the location of the first leaf 302. The location of the first intersection 210 can be expressed in the first intersection relative location 524. The first intersection record 424 of FIG. 5 can include the first intersection relative location 524.

Information and data, such as the topology data 420 of FIG. 4, can include location information for intersection points expressed in absolute geographic coordinates. It is noted, however, that absolute geographic coordinates can be lengthy and excessive.

The intersection relative location can express location information of the intersection relative to the location of a leaf which includes the intersection. For example, the location of the first intersection 210 can be expressed relative to a leaf origin 602 of the first leaf 302. The leaf origin 602 can be a point in a leaf, such as the northwestern corner of the first leaf 302. The first intersection relative location 524 can include the location of first intersection 210 as an offset from the leaf origin 602. For example, the first intersection relative location 524 can be expressed as a combination of a longitude offset and a latitude offset from the leaf origin 602. As a further example, the first intersection relative location 524 can be expressed in polar coordinates, with a distance from the leaf origin 602 and a direction from the leaf origin 602.

Since a leaf can be a specific geographic area, the offsets for any intersection point can be represented by a relatively small number compared to absolute geographic coordinates for the same intersection point. An intersection relative location, such as the first intersection relative location 524, can be expressed with a vint as described earlier.

The navigation system 200 of FIG. 2 with map compression can generate a relative expression for any intersection point of the compressed map data. It has been discovered that the use of intersection relative locations, such as the first intersection relative location 524 can substantially reduce the amount of storage required to store the location information of intersection points.

The physical transformation of intersection relative locations results in movement in the physical world, such as people using the navigation system 200 or vehicles, based on the operation of the navigation system 200. As the movement in the physical world occurs, the movement itself creates additional information that is converted back to the intersection relative locations for the continued operation of the navigation system 200 and to continue the movement in the physical world.

Referring now to FIG. 7, therein is shown an illustration of an edge relative location. An edge relative location can identify an origin intersection of an incoming edge, or a destination intersection of an outgoing edge. The navigation system 200 of FIG. 2 can generate navigation routing information using information associated with intersections and edges such as the edge relative location.

FIG. 7 shows how the first relative origin 520 can relate the location of the first intersection 210 to the fourth intersection 220. FIG. 7 shows a portion of the quad-tree representation of the spatially-aware identification 300 of FIG. 3. For illustrative purposes, the quad-tree is shown with nodes shown as circles, and data points shown as squares with an internal cross. The illustration shows the first intersection 210 in the first leaf 302 and the fourth intersection 220 in the third leaf 306. The first internal node 312 can be a common internal node of the quad-tree for the first intersection 210 and the fourth intersection 220.

As already described, a topology data record, such as the first intersection record 424 of FIG. 5, can include the first relative origin 520, which can be an edge relative location of an origin intersection for an incoming edge of the first intersection 210. In this example, the first relative origin 520 can be the location of the fourth intersection 220 relative to the first intersection 210. Having the location of the first intersection 210 and the first relative destination 506 can indicate to the navigation system 200 the origin and destination intersections of the third road segment 222 of FIG. 2.

The edge relative location can indicate to the navigation system 200 how to traverse to another data point across the quad-tree. For example, the navigation system 200 can traverse up through the layers of the quad-tree from the first intersection 210 to the first internal node 312, as represented by one of three dashed arrows. The navigation system 200 can then traverse the quad-tree from the first internal node 312 to the third leaf 306, which can include the fourth intersection 220, as represented by another dashed arrow. The navigation system 200 can then traverse the third leaf 306 to the fourth intersection 220 as represented by the third dashed arrow.

An edge relative location, such as the first relative origin 520, can be a composite expression, which can include the number of layers from the first intersection 210 up to the first internal node 312. The first relative origin 520 can also include the partial path to the third leaf 306 from the first internal node 312. The first relative origin 520 can also include a sequential identification of the fourth intersection 220 in the third leaf 306. The navigation system 200 can use the first relative origin 520 of the first intersection record 424 to determine if it can include the fourth intersection 220 to generate navigation routing information.

FIG. 7 illustrates an incoming edge of the first intersection 210, although it is understood that an edge relative location can describe an outgoing edge of an intersection. For example, the first relative destination 506 of FIG. 5 can be an edge relative location describing the location of the second intersection 214 of FIG. 2 as the destination of the first road segment 212 of FIG. 2 from the first intersection 210.

The first relative origin 520 can also include a term to indicate whether there are additional edges between the first intersection 210 and the fourth intersection 220. More than one road segment can lead between two intersections. An edge relative location can indicate to the navigation system 200 that there is a choice of edges between two intersections with multiple connecting edges.

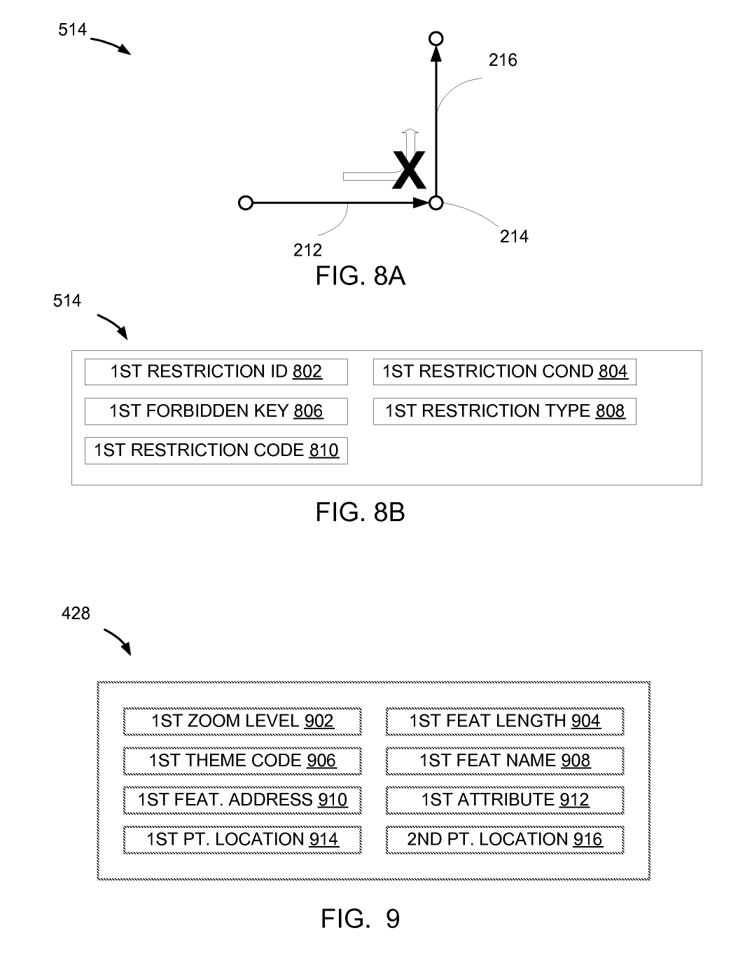

Referring now to FIGS. 8A and 8B, therein are shown various views of an example of a restriction. Thoroughfares can be subjected to a variety of restrictions or ordinances to control vehicular traffic, constrain parking, and apply other limitations which can be ascribed to a thoroughfare, an intersection point, a parking lot, or other places where traffic control may be required. Examples of restrictions can include turn limitations, one-way streets, or limitations during specified time windows. Restrictions can be included in a topology data record with a restriction record, such as the first restriction 514 of the first intersection record 424 of FIG. 5.

FIG. 8A shows an illustration of the first road segment 212 and the second road segment 216 connected at the second intersection 214. The primary route 208 of FIG. 2 is shown with the first road segment 212 and the second road segment 216, with a left turn at the second intersection 214. FIG. 8A shows the first restriction 514, which can be included with the first intersection record 424 of FIG. 5. For the purpose to describe the navigation system 200 of FIG. 2 with map compression, the first restriction 514 is shown to forbid a left turn from the first road segment 212 onto the second road segment 216. However, it is understood that the primary route 208 is shown in FIG. 2 without the first restriction 514, and that the first restriction 514 is shown in FIG. 8A for illustrative purposes.

A restriction can apply to one or more edges. Restrictions applying to one edge only can include, for example, restricted parking or one-way traffic. Other restrictions can apply to two edges. For example, a left-turn restriction such as the first restriction 514 can be described in the first intersection record 424 of the first intersection 210 and an intersection record of the second intersection 214. Other restrictions can impact more than two edges, such as a limitation on u-turns.

FIG. 8B shows an example of a restriction record, such as the first restriction 514. The restriction record can include a first restriction identification 802. The first restriction 514 can include a restriction identification, such as a first restriction identification 802, which can be a unique identifier for the first restriction 514 in the first restriction 514. The first restriction identification 802 can be expressed with a vint to save storage space.

The first restriction 514 can also include a first restriction condition 804. A restriction condition, such as the first restriction condition 804, can describe a condition under which the first restriction 514 can apply. The first restriction condition 804 can be expressed with a vint. Examples of a restriction condition can include enforcement on a weekday only, during certain hours only, or only on specific dates.

The first restriction 514 can also include a forbidden key. A forbidden key, such as the first forbidden key 806 can indicate whether the first restriction 514 describes a forbidden action. Examples of such restrictions include no-left turn, or no parking. Examples of a restriction which does not use a forbidden key can include handicapped parking, permit parking, carpool lanes, or other restrictions which can apply selectively.

The first restriction 514 can also include a restriction type. A restriction type, such as the first restriction type 808 can indicate the type of restriction. Examples of the first restriction type 808 can include a guarded gateway, key access, turn restrictions, and parking restrictions.

The first restriction 514 can also include a restriction code. A restriction code, such as a first restriction code 810 can indicate the starting edge, or the ending edge, or an intermediate edge of a restriction. Restrictions can involve more than one edge, such as the first restriction 514, which prohibits a left-turn from the first road segment 212 to the second road segment 216. The starting edge of the first restriction is the first road segment 212, and the ending edge of the first restriction 514 is the second road segment 216. The first restriction code 810 can indicate that the first road segment 212 is the starting edge of the first restriction 514. A corresponding restriction code in the intersection record for the second intersection 214 can indicate that the second road segment 216 can be the ending edge of the first restriction 514.

The navigation system 200 with map compression can retrieve the restrictions from map data, and compress a restriction record, such as the first restriction 514. For example, the navigation system 200 can compress the first forbidden key 806, the first restriction type 808, and the first restriction code 810, into one byte in a binary notation scheme. The same byte can include an indication whether a subsequent restriction can apply to the same edge.

Referring now to FIG. 9, therein is shown an illustration of a shape data record for map rendering. FIG. 9 shows a detail of the first feature record 428, which can be included with the shape data 426 of FIG. 4. The navigation system 200 of FIG. 2 with map compression can include shape information in the shape data 426 for the purpose of displaying map features on a display. The features can be naturally occurring, such as rivers, lakes, or hills. The features can also be man-made objects such as roads, buildings, or administrative regions. The navigation system 200 can compress shape information into a shape data record for the purpose of compact storage, and ease of retrieval with traversal.

Features can belong in different categories, such as route features, area features, line features, or POI features. Route features can describe the shape of roads and highways, for example. Area features can describe the shape of lakes, meadows, or buildings, for example. Line features can describe the borders of administrative areas, cultural areas, or other distinguishable areas. POI features can describe locations and services, which can be points of interest. Shape information, such as the first feature record 428, for one or more features can be included with the shape data 426.

The first feature record 428 can include a first zoom level 902. The first zoom level 902 can be the first element of a record of the first feature record 428. A map rendering module can read the first zoom level 902, and determine at what level of magnification of a display the feature should be visible. For example, a municipal park can be visible in a map rendering of a city, while it can be invisible in a map rendering of a state. As a further example, a historic building can be visible in a map rendering of a city block, while it can be invisible in a map rendering of a city.

The first zoom level 902 can be the first entry in the record. If the magnification of a display is such that the first zoom level 902 is inappropriate for display, the navigation system 200 can skip the remainder of the first feature record.

The first feature record 428 can also include a first feature length 904. The first feature length 904 can indicate the number of data entries included with the feature record. If the zoom level is inappropriate for display at a certain magnification, the first feature length 904 can indicate to a map rendering module of the navigation system 200 how many data entries to skip to move to a new shape record.

The first feature record 428 can also include a first feature theme code 906. The first feature theme code 906 can indicate the nature of the shape described in the first feature record 428. For example, the feature theme code can identify or represent any navigational feature such as a park, a thoroughfare, a neighborhood, or a waterfront. As a further example, the feature can be a notable building such as a shopping mall, historic building, municipal building or business park. The first feature theme code 906 can be omitted from a feature record. For example, a feature record for a point of interest (POI) can omit a theme code.

The first feature record 428 can also include a first feature name 908. The first feature name 908 can represent the name of the shape, such that the name can be presented with the shape. The name can consist of a number of words, and each word in the name can have a word identifier. The word identifiers can be defined in a dictionary of word identifiers. The dictionary of word identifiers can associate each word identifier of a name, such as the first feature name 908, to a word in the name of a shape.

The first feature address 910 can also be a string of word identifiers from the same word identifier dictionary. A feature address can be optional for some features, such as an area, a road or a line feature. The first feature address 910 can describe the address location of a POI feature, such as a store, a museum or other location.

The first feature attributes 912 can describe one or more attributes of a shape. The first feature attributes 912 can be expressed as a vint to indicate multiple attributes of a shape. Feature attributes can include additional information for the purpose of displaying a shape. For example, feature attributes can include additional wording to be displayed with a shape, or a specific color to be used for displaying the shape.

A first point location 914 and a second point location 916 can be point locations marking the boundary of a feature. The point locations can indicate the boundary of a park, for example. The location of the first point location 914 can be expressed as an intersection relative location in a leaf which contains the shape. For example, the first point location 914 can be expressed relative to the northwest corner of its leaf Subsequent points in the first feature record 428 can be expressed relative to the immediate previous point. For example, the second point location 916 can be expressed relative to the first point location 914.

The first feature record 428 can include different numbers of point locations, such as the first point location 914 and the second point location 916. More points in the first feature record 428 can enable a shape with more detail and more precision. A feature with one point location can represent a POI feature, such that the point indicates an address of a location.

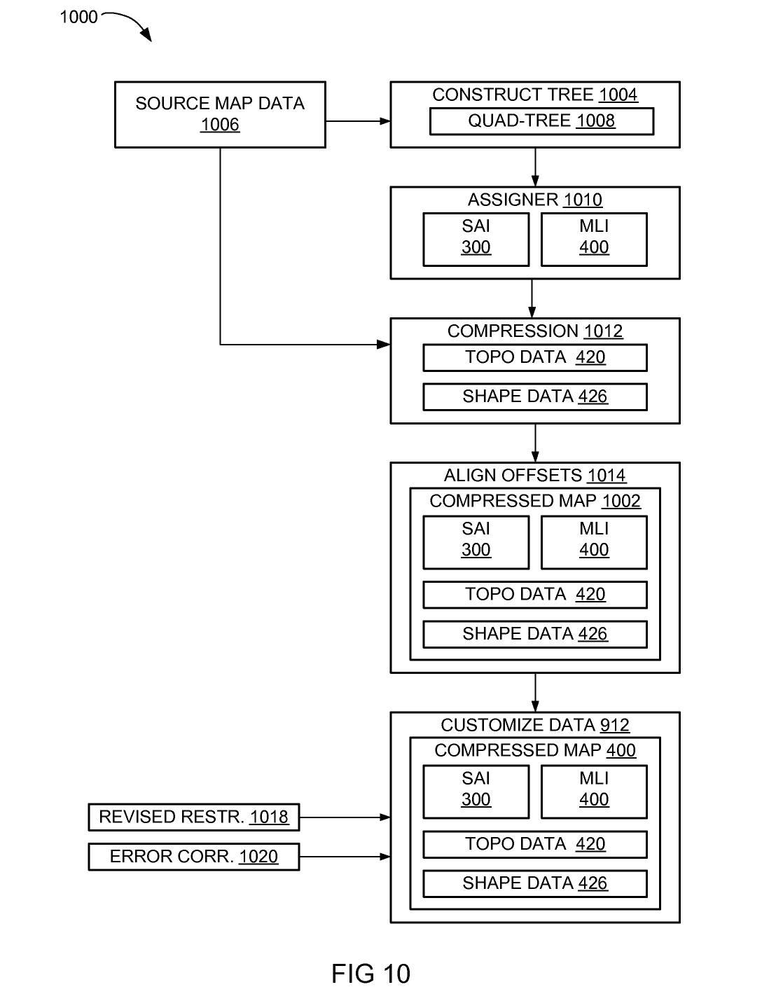

Referring now to FIG. 10, therein is shown a flow chart of a map data compression flow 1000. The map data compression flow 1000 of the navigation system 200 of FIG. 2 with map compression can generate compressed map data 1002 for the navigation functions and modules of the navigation system 200. The map data compression flow 1000 can preconstruct the multi-layered index 400, with the topology data 420 and the shape data 426. The topology data 420 can include intersection records, such as the first intersection record 424 of FIG. 5. The shape data 426 can include shape records such as the first feature record 428 of FIG. 9.

A construct tree module 1004 can receive data such as source map data 1006. The construct tree module 1004 can generate a quad-tree 1008. An assigner module 1010 can receive the quad-tree 1008, and can generate the multi-layered index 400 with the spatially-aware identification 300. A compression module 1012 can receive the spatially-aware identification 300 and the multi-layered index 400 from the assigner module 1010. The compression module 1012 can also receive the source map data 1006 and generate the topology data 420 and the shape data 426. An align offsets module 1014 can receive the topology data 420, the shape data 426, the spatially-aware identification 300 and the multi-layered index 400, and can generate the compressed map data 1002.

The construct tree module 1004 can receive the source map data 1006. The source map data 1006 can be provided from a source such as an outside vendor. The construct tree module 1004 can organize the data of the source map data 1006 into the quad-tree 1008. The construct tree module 1004 can generate the quad-tree 1008 with a limit of two hundred fifty-six data points or intersections in each leaf. The construct tree module 1004 can generate the quad-tree 1008 for the entire territory covered by the source map data 1006.

The construct tree module 1004 can also insert internal nodes into the quad-tree 1008, such as the first internal node 312 of FIG. 3. The construct tree module 1004 can generate the block index 402 of FIG. 4, with a block identification, a leaf count, and a leaf offset. For example, the construct tree module 1004 can generate the first block identification 314 of FIG. 4, the first leaf count 404 of FIG. 4, and the first leaf offset 406 of FIG. 4.

The construct tree module 1004 can generate a leaf index, with a relative leaf identification, a topology offset, a topology count, a shape offset and a shape count. For example, the construct tree module 1004 can generate the leaf index 408 of FIG. 4, the first relative leaf identification 316 of FIG. 4, the first topology offset 412 of FIG. 4, the first topology count 414 of FIG. 4, the first shape offset 416 of FIG. 4 and the first shape count 418 of FIG. 4. The block index 402 and the leaf index 408 can be included with the multi-layered index 400.

The assigner module 1010 can receive the quad-tree 1008 from the construct tree module 1004. The assigner module 1010 can generate the spatially-aware identification 300 and the multi-layered index 400. The assigner module 1010 can also insert offsets for intersections in the topology data records of intersections, such as the first intersection index 422 of FIG. 4. As previously described, the first block identification 314, the first relative leaf identification 316 and the first intersection index 422 can comprise a unique identification for a data point of the map area, such as an intersection.

The compression module 1012 can receive the source map data 1006. The compression module 1012 can also receive the spatially-aware identification 300 and the multi-layered index 400, and can preconstruct the topology data 420 and the shape data 426. The compression module 1012 can generate intersection relative locations such as the first intersection relative location 524 of FIG. 5. The compression module 1012 can also calculate the counts of incoming edges, such as the first in-edge count 516 of FIG. 5, and the counts of outgoing edges, such as the first out-edge count 502 of FIG. 5. The compression module 1012 can insert offsets in the topology data such as the first out-edge offset 504 of FIG. 5, the first in-edge offset 518 of FIG. 5 and the first origin offset 522 of FIG. 5.

The compression module 1012 can also calculate relative locations for incoming edges, such as the first relative origin 520 of FIG. 5, and the first relative destination 506 of FIG. 5. The compression module 1012 can convert the absolute location values from the source map data into the edge relative location with a vint for limiting the size of the relative locations.

The compression module 1012 can generate attribute counts such as the first attribute count 508 of FIG. 5. The compression module 1012 can also generate the restriction records, such as the first restriction 514 of FIG. 8.

The compression module 1012 can also compress shape information from the source map data 1006 in the shape records of the shape data 426 such as the first feature record 428. The compression module 1012 can retrieve a zoom level, such as the first zoom level 902 of FIG. 9 and calculate the length of the shape record, such as the first feature length 904 of FIG. 9. The compression module 1012 can also retrieve a theme code, such as the first feature theme code 906 of FIG. 9. The compression module 1012 can extract a name, such as the first feature name 908 of FIG. 9, and an address, such as the first feature address 910 of FIG. 9. The compression module 1012 can also retrieve attributes such as the first feature attributes 912 of FIG. 9, and the point locations such as the first point location 914 of FIG. 9.

The compression module 1012 can send the topology data 420 and the shape data 426 including the topology records and the shape records, to the align offsets module 1014. The align offsets module 1014 can receive the topology data 420 and the shape data 426. The align offsets module 1014 can align offsets of edges and intersections of the topology data 420. For example, the topology data 420 can include the first intersection record 424 of FIG. 5. As the compression module 1012 generates the first intersection record 424, offsets such as the first out-edge offset 504 of FIG. 5 can require refinement. The align offsets module 1014 can complete the refinement of the offsets.

The align offsets module 1014 can assemble the compressed map data 1002 having the spatially-aware identification 300, the multi-layered index 400, the topology data 420 and the shape data 426. The align offsets module 1014 can send the compressed map data 1002 to a customize data module 1016.

The customize data module 1016 can receive the compressed map data 1002 and can generate an updated version of the compressed map data 1002. The customize data module 1016 can also submit a revised restriction 1018 and an error correction 1020. The revised restriction 1018 and the error correction 1020 can be submitted from an input device of the navigation system 200.

The revised restriction 1018 can be a modification to a restriction record in the compressed map data 1002. The customize data module 1016 can enable a new restriction in the topology data 420, or a modification to an existing restriction in the topology data 420. For example, a user of the navigation system 200 can choose to impose a speed restriction on a road segment, such as the first road segment 212 of FIG. 2. A user of the navigation system 200 can submit the revised restriction 1018 to the first intersection record 424 of FIG. 5 to change a speed limit. Revised restrictions can include a variety of personal preferences, for example, a user may choose never to use a particular street, or may choose never to use freeways. Further examples can include preferred restrictions on left-turns at selected intersections, or speed limits other than the legal speed limit.

The error correction 1020 can also be directly edited in the compressed map data 1002. For example, if a street name has been misspelled in the source map data 1006, the customize data module 1016 can receive the error correction 1020 with the updated street name. It has been discovered that the navigation system 200 can provide the means to rapidly and efficiently modify data to adapt to personal preferences, or to correct flaws. This capability of the navigation system 200 with map compression enables a more robust, more versatile system.

The physical transformation of the modified map data results in movement in the physical world, such as people using the navigation system 200 or vehicles, based on the operation of the navigation system 200. As the movement in the physical world occurs, the movement itself creates additional information that is converted back to the compressed map data for the continued operation of the navigation system 200 and to continue the movement in the physical world.

It has also been discovered that the compressed map data 1002 of the navigation system 200 can occupy a significantly smaller storage than the source map data 1006. For example, map data covering the 48 contiguous states of the USA can require over 6 GBytes of storage space, while the navigation system 200 with map compression can compress the same map data into less than 2 GBytes. This can be a significant economy of storage which enables the compressed map data 1002 to be stored on smaller memory devices in more compact and portable devices.

The physical transformation of the navigation system 200 with map compression results in movement in the physical world, such as people using the navigation system 200 or vehicles, based on the operation of the navigation system 200. As the movement in the physical world occurs, the movement itself creates additional information that is converted back to the compressed map data 1002 for the continued operation of the navigation system 200 and to continue the movement in the physical world.

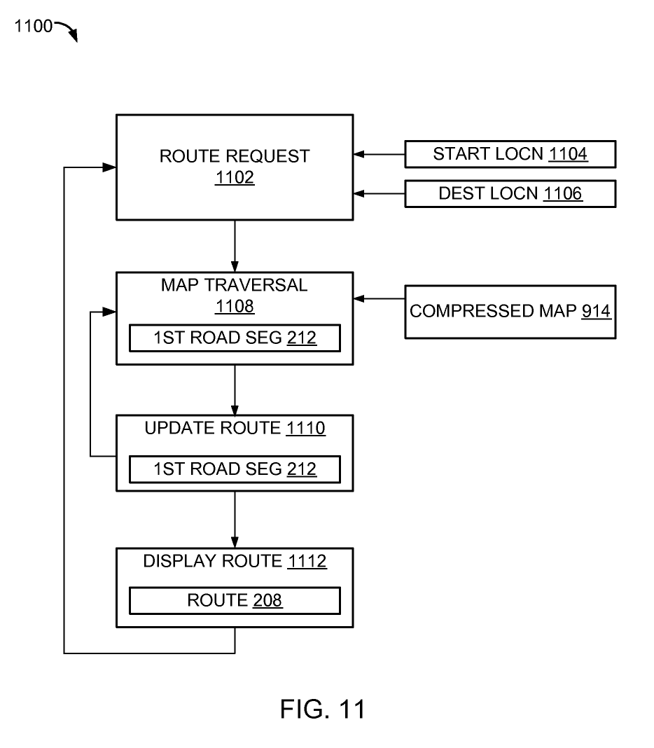

Referring now to FIG. 11, therein is shown a flow chart of a route generation flow 1100. The route generation flow 1100 of the navigation system 200 of FIG. 2 with map compression illustrates a search and retrieval of an edge of the compressed map data 1002 for the purpose of generating a route, such as the primary route 208. The route generation flow 1100 can select an intersection, such as the first intersection 210 of FIG. 2, based on the multi-layered index 400 of FIG. 4 of the spatially-aware identification 300 of FIG. 3 for inclusion in a generated route. The route generation flow 1100 can generate the primary route 208 based on the first intersection 210 of FIG. 2 for displaying on a device, such as the device 202 of FIG. 2.

A route request module 1102 can receive a starting location 1104 and a destination location 1106. The starting location 1104 can be an intersection or other location from which a navigable route is to be generated. The destination location 1106 can be the target location for the end point of the navigable route. The route request module 1102 can receive the starting location 1104 and the destination location 1106 from an input of the navigation system 200.

The route request module 1102 can send the starting location 1104 and the destination location 1106 to a map traversal module 1108. The map traversal module 1108 can determine the relative location of the starting location 1104, and can traverse the multi-layered index 400 with the spatially-aware identification 300 to an intersection record associated with the starting location 1104, such as the first intersection record 424 of FIG. 4 associated with the first intersection 210 in the topology data 420 of FIG. 4. The map traversal module 1108 can also select an intersection, such as the third intersection 218 of FIG. 2 associated with the destination location 1106.

The map traversal module 1108 can then search for an edge which leads towards the destination. The route request module 1102 can traverse the compressed map data 1002 to the first intersection record 424. The map traversal module 1108 can query the outgoing edges of the first intersection record 424. For example, the map traversal module 1108 can determine that there is no outgoing edge of the first intersection 210 leading to the destination location 1106 at the third intersection 218. The map traversal module 1108 can also determine which outgoing edge of the first intersection leads towards the destination location 1106.

The map traversal module 1108 can traverse the compressed map data 1002 to the destination of edges from the first intersection 210. For example, the map traversal module 1108 can traverse the multi-layered index 400 of the spatially-aware identification 300 to the first relative destination 506 associated with the second intersection 214 of FIG. 2. The map traversal module 1108 can determine that the first road segment 212, leading from the first intersection 210 to the first relative destination 506 at the second intersection 214, can be an appropriate edge for the primary route 208.

The map traversal module 1108 can select the first road segment 212 based on the first intersection 210 to be included with the primary route 208. The map traversal module 1108 can retrieve the first time attribute 510 of FIG. 5 and the first length attribute 512 of FIG. 5. The map traversal module 1108 can select the first road segment 212 based on the first time attribute 510 for a route with a priority on a shortest time for the route. The map traversal module 1108 can also select the first road segment 212 based on the first length attribute 512 for a route with a priority on a shortest distance for the route.

The map traversal module 1108 can also retrieve the first restriction 514. The first restriction 514 can include a modification to a restriction, such as the revised restriction 1018 of FIG. 10. The map traversal module 1108 can select the first road segment 212 based on the first restriction 514 of FIG. 5. If the first restriction 514 provides an impediment to using the first road segment 212 in the primary route 208, the map traversal module 1108 will search for an alternative to the first road segment 212. The revised restriction 1018 can also provide an impediment to using the first road segment 212, and the map traversal module 1108 can look for an alternative road segment to the first road segment 212.

The map traversal module can send the first road segment 212 to an update route module 1110. The update route module 1110 can update the primary route 208 with the first road segment 212 associated with the second intersection 214 to the primary route 208. If the primary route 208 is not complete, the route generation flow can return to the map traversal module 1108. The map traversal module 1108 can query outgoing edges of the second intersection 214 for an appropriate edge, which can also be added to the primary route 208.

If the primary route 208 is a complete route from the starting location 1104 to the destination location 1106, the update route module 1110 can send the primary route 208 to a display route module 1112.

The display route module 1112 can receive the primary route 208 from the update route module 1110. The display route module 1112 can display the primary route 208 on a display with the navigation system 200. The display route module 1112 can then return to the route request module 1102 to await a new request for routing information.

The route generation flow 1100 can generate a navigable route by selecting an intersection, determining a road segment associated with the intersection connecting to another intersection. The route generation flow 1100 can assemble one or more road segments which can lead from the starting location 1104 to the destination location 1106. The route generation flow 1100 can consider multiple routes based on preferences for the least distance or least time required, determined by the time attributes and the length attributes of edge information.

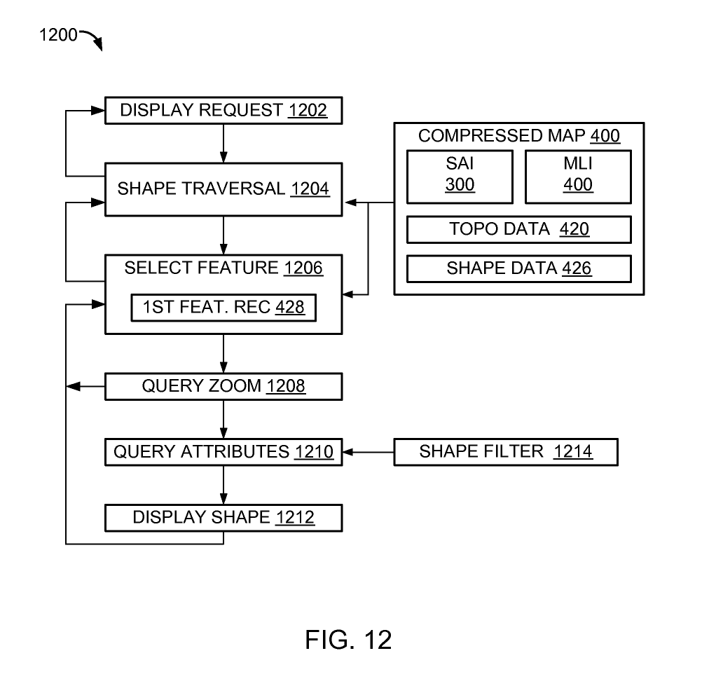

Referring now to FIG. 12, therein is shown a flow chart of a shape selection 1200 for map rendering. Map rendering can include the display of images which represent shapes in a region on a device with the navigation system 200 of FIG. 2. For example, the primary route 208 of FIG. 2 is shown with road segments, such as the first road segment 212 of FIG. 2, and significant buildings such as the first feature 224 of FIG. 2 and the second feature 226 of FIG. 2. The features and shapes displayed in FIG. 2 enhance the display of the primary route 208. The display of road segments and buildings on the display 206 of FIG. 2 can be achieved by map rendering in the shape selection 1200 of the navigation system 200.

Map rendering can enable the display of shapes which can be included with the shape data 426, with shape records such as the first feature record 428. Map rendering in the navigation system 200 can be accomplished by selecting a shape associated with an area to be displayed, and by determining whether it is appropriate to display the shape.

A display request module 1202 can generate a request for an area display. The display request module 1202 can be received in a number of ways. An example of a display request module 1202 can be an automatic function of the navigation system 200 following the generation of navigation routing information. The route generation flow 1100 can generate the primary route 208, and the navigation system 200 can automatically send the display request module 1202 to display the primary route 208 with appropriate shapes of the same area. A further example of the display request module 1202 can be a request to view a map of a municipality, while not necessarily displaying a route.

The shape selection 1200 can go to a shape traversal module 1204. The shape traversal module 1204 can traverse the compressed map data 1002 to the shape data 426 of the compressed map data 1002. The display request module 1202 can include the identity of a leaf, whose shapes can be displayed by the navigation system 200. The display request module 1202 can include the identity of a leaf, whose shapes can be displayed by the navigation system 200. For example, the display request module 1202 can include the first leaf 302 of FIG. 3 with the first block identification 314 of FIG. 3 and the first relative leaf identification 316 of FIG. 4. The shape traversal module 1204 can traverse the multi-layered index 400 to the first relative leaf identification 316, and can locate the first feature record 428 of FIG. 4 associated with the first feature 224 of FIG. 2.

The shape traversal module 1204 can send shape records associated with the first leaf 302 to a select feature module 1206. The select feature module 1206 can select each shape record individually for determining whether the shape can be displayed. The select feature module 1206 can send a shape record, such as the first feature record 428 to a query zoom module 1208.

The query zoom module 1208 can retrieve a zoom level of a shape. For example, the query zoom module 1208 can retrieve the first zoom level 902 of FIG. 9. The query zoom module 1208 can compare the first zoom level 902 with the scale of the map area to be displayed.

If the query zoom module 1208 determines that the first feature 224 can be omitted from the display, then the shape selection 1200 can return to the select feature module 1206 to send another shape of the first leaf 302. If the query zoom module 1208 determines that the first feature 224 can be displayed, a query attributes module 1210 can retrieve the other information of the first feature 224, such as the first feature theme code 906 of FIG. 9, the first feature name 908 of FIG. 9, the first point location 914 of FIG. 9, etc.

The query attributes module 1210 can send information about the first feature 224 to a display shape module 1212. The display shape module 1212 can operate a display, such as the display 206 of FIG. 2 on the user interface 204 of FIG. 2 to present an image of the first feature 224. The display shape module 1212 can return to the select feature module 1206 to select another shape of the first leaf 302. If all the shapes of the first leaf 302 have been sent to the query zoom module 1208, the select feature module 1206 can return to the shape traversal module 1204.

The query attributes module 1210 can receive a shape filter 1214. The shape filter 1214 can be received from an input of the navigation system 200, and can filter the presentation of shapes on the display 206. For example, a user of the navigation system 200 can choose to display streets and thoroughfares only, and can send the shape filter 1214 to the query attributes module 1210 to filter the shapes to be presented. The query attributes module 1210 can receive the shape filter 1214, and can prevent the display of some shapes such as parks, rivers, and large buildings. The shape filter 1214 can be sent according to user preferences, such that the navigation system 200 can render maps according to the user preferences described in the shape filter 1214.

The shape traversal module 1204 can determine if a different leaf can be reviewed for presenting shapes on the display 206. If the shape traversal module 1204 selects another leaf, the select feature module 1206 can send the shapes of the leaf to the query zoom module 1208. Otherwise, if the shape traversal module 1204 determines that no more leaves should be reviewed, the shape traversal module 1204 can return to the display request module 1202 to await a new request for display of shapes.

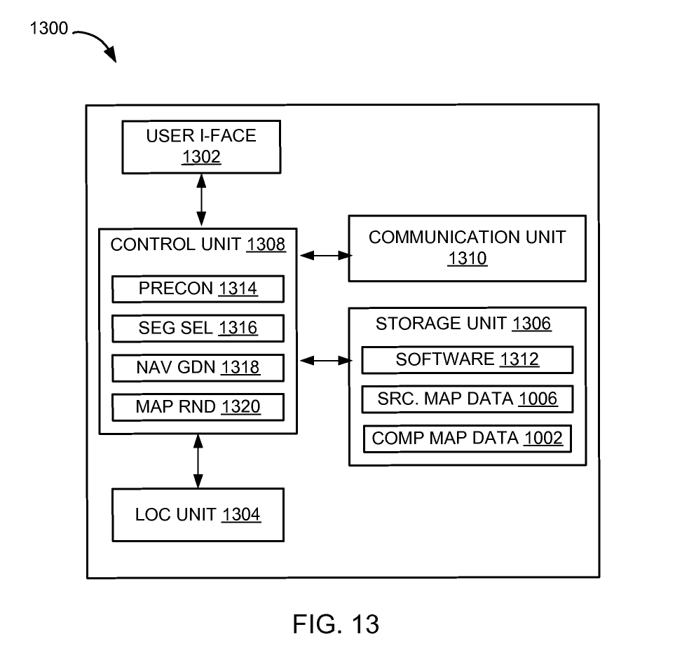

Referring now to FIG. 13, therein is shown a block diagram of a navigation system 1300 with map compression in a second embodiment of the present invention. The navigation system 1300 can be the second device 104 of FIG. 1. For example, the navigation system 1300 can be any of a variety of devices, such as a cellular phone, a personal digital assistant, a notebook computer, or an entertainment device. The navigation system 1300 can be a standalone device, or can be incorporated with a vehicle, for example a car, truck, bus, or train.

As a further example, the navigation system 1300 can be a particularized machine, such as a mainframe, a server, a cluster server, a rack mounted server, or a blade server, or as more specific examples, an IBM System z10™ Business Class mainframe or a HP ProLiant ML™ server.

The navigation system 1300 can include a user interface 1302, a location unit 1304, a storage unit 1306, a control unit 1308, such as a processor, and a communication unit 1310. The user interface 1302 can include an input device and an output device. For example, the output device can include a display, a projector, a video screen, a speaker, or any combination thereof. Examples of the input device include a keypad, a touchpad, soft-keys, a keyboard, a microphone, or any combination thereof to provide data and communication inputs.

For illustrative purposes, the navigation system 1300 is described with discrete functional modules, although it is understood that the navigation system 1300 can have a different configuration. For example, the control unit 1308, the communication unit 1310 and the user interface 1302 may not be discrete functional modules, but may have one or more of the aforementioned modules combined into one functional module. The communication unit 1310 can include active or passive components, such as microelectronics or an antenna, for interaction with a communication channel such as the communication path 106 of FIG. 1.

The control unit 1308 can execute software 1312 and can provide the intelligence of the navigation system 1300. As an example, the software 1312 can include the navigation system 200 of FIG. 2. The control unit 1308 can operate the user interface 1302 to display information generated by the navigation system 1300, or receive information for use by the navigation system 1300. The control unit 1308 can include a preconstruction module 1314, a segment selection module 1316, a navigation guidance module 1318, and a map rendering module 1320. The user interface 1302 can receive the source map data 1006. The user interface 1302 can also receive the revised restriction 1018 of FIG. 10 and the error correction 1020 of FIG. 10. The preconstruction module 1314 of the control unit 1308 can operate the map data compression flow 1000 of FIG. 10 to generate the compressed map data 1002.

The user interface 1302 can also receive the starting location 1104 and the destination location 1106 of FIG. 11. The segment selection module 1316 of the control unit 1308 can operate the route request module 1102 of FIG. 11 and the map traversal module 1108 of FIG. 11 to generate the primary route 208 of FIG. 2. The navigation guidance module 1318 of the control unit 1308 can operate the update route module 1110 of FIG. 11 and the display route module 1112 of FIG. 11.

The user interface 1302 can also receive the display request module 1202 of FIG. 12. The map rendering module 1320 of the control unit 1308 can operate the shape selection 1200 of FIG. 12.

The control unit 1308 can also operate the user interface 1302 to display information generated by the navigation system 1300. For example, the control unit can operate the user interface 1302 to display a route, such as the primary route 208 of FIG. 2, and a shape such as the first feature 224 of FIG. 2.

The storage unit 1306 can include the software 1312, setup data, and other data of the navigation system 1300, which can include the map data compression flow 1000 of FIG. 10, the route generation flow 1100 of FIG. 11, and the shape selection 1200 of FIG. 12. The control unit 1308 can store the source map data 1006 in the storage unit 1306. The control unit 1308 can also store the compressed map data 1002 in the storage unit 1306.

The location unit 1304 of the navigation system 1300 can receive a location reading of the navigation system 1300. The location unit 1304 can be implemented in many ways. For example, the location unit 1304 can be a navigational component providing a location reading, such as a global positioning system (GPS), inertial navigation system, cell-tower location system, accelerometer location system, or any combination thereof. The location reading can be used as the starting location 1104 for the primary route 208.

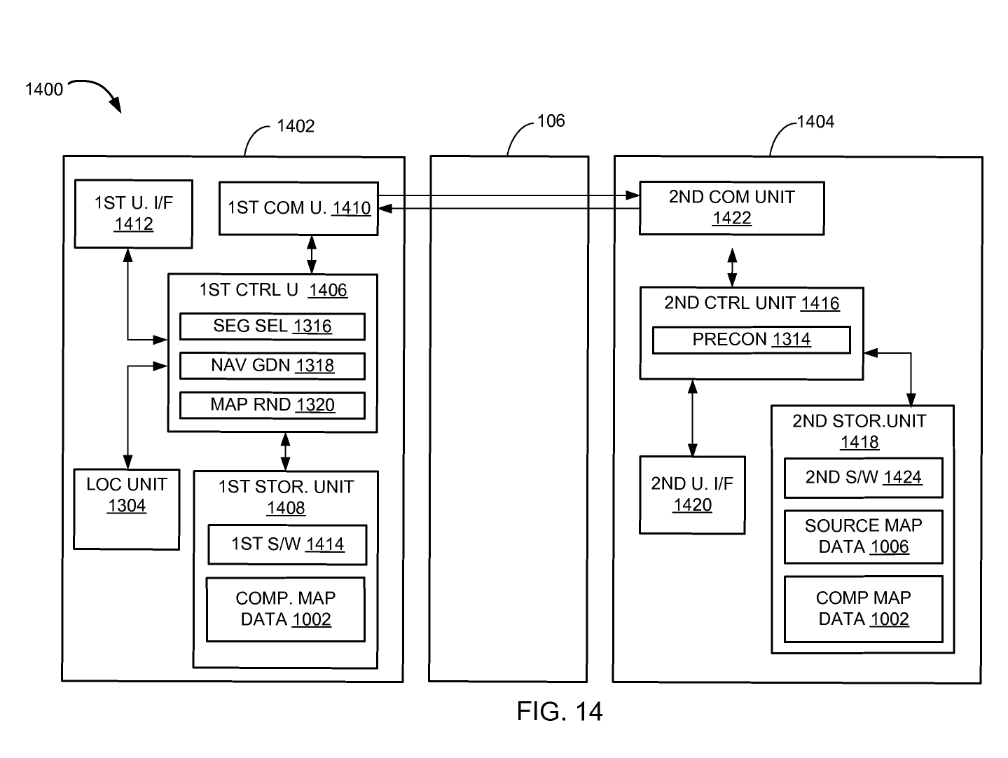

Referring now to FIG. 14, therein is shown a block diagram of a navigation system 1400 with map compression in a third embodiment of the present invention. The navigation system 1400 can include a first device 1402, a second device 1404, and the communication path 106. The first device 1402 can communicate with the second device 1404 over the communication path 106.

For illustrative purposes, the navigation system 1400 is shown with the first device 1402 as a client, although it is understood that the navigation system 1400 can have the first device 1402 as a different type of device. For example, the first device 1402 can be a server.

Also for illustrative purposes, the navigation system 1400 is shown with the second device 1404 as a server, although it is understood that the navigation system 1400 can have the second device 1404 as a different type of device. For example, the second device 1404 can be a client.

As a further example, the first device 1402 can be a particularized machine, such as a portable computing device, a thin client, a notebook, a netbook, a smartphone, a personal digital assistant, or a cellular phone, and as specific examples, an Apple iPhone™, Palm Centro™, or Moto Q Global™. Yet another example, the second device 1404 can be a particularized machine, such as a mainframe, a server, a cluster server, a rack mounted server, or a blade server, or as more specific examples, an IBM System z10™ Business Class mainframe, or a HP ProLiant ML™ server.

For brevity of description for this embodiment of the present invention, the first device 1402 will be described as a client device and the second device 1404 will be described as a server device. The present invention is not limited to this selection for the type of devices. The selection is an example of the present invention.

The first device 1402 can include, for example, a first control unit 1406, such as a processor, a first storage unit 1408, a first communication unit 1410, the location unit 1304, and the first user interface 1412. For illustrative purposes, the navigation system 1400 is shown with the first device 1402 described with discrete functional modules, although it is understood that the navigation system 1400 can have the first device 1402 in a different configuration. For example, the first control unit 1406, the first communication unit 1410, the first user interface 1412 may not be discrete functional modules, but may have one or more of the aforementioned modules combined into one functional module.

The first control unit 1406 can include the segment selection module 1316, the navigation guidance module 1318 and the map rendering module 1320. The first control unit 1406 can execute first software 1414 from the first storage unit 1408 and provide the intelligence of the first device 1402. As an example, the first software 1414 can include a portion of the navigation system 200 of FIG. 2. The first control unit 1406 can operate the first user interface 1412 to display information generated by the navigation system 1400.

The first control unit 1406 can also execute the first software 1414 for the other functions of the navigation system 1400. The segment selection module 1316 can operate the route request module 1102 of FIG. 11 and the map traversal module 1108 of FIG. 11. The navigation guidance module 1318 can operate the update route module 1110 of FIG. 11 and the display route module 1112 of FIG. 11. The map rendering module 1320 of the control unit 1308 can operate the shape selection 1200 of FIG. 12.

The first storage unit 1408 can be implemented in a number of ways. For example, the first storage unit 1408 can be a volatile memory, a nonvolatile memory, an internal memory, or an external memory. The first storage unit 1408 can include the first software 1414, and the compressed map data 1002.

The first user interface 1412 can include an output device and an input device. For example, an output device can include a projector, a video screen, a speaker, or any combination thereof. Examples of the input device include a keypad, a touchpad, soft-keys, a keyboard, a microphone, or any combination thereof to provide data and command inputs. The first user interface 1412 can receive input to the first device 1402, such as the starting location 1104 of FIG. 11 and the destination location 1106 of FIG. 11.

The location unit 1304 of the first device 1402 can generate a current location of the navigation system 1400. The location unit 1304 can be implemented in many ways. For example, the location unit 1304 can be a global positioning system (GPS), inertial navigation system, cell-tower location system, accelerometer location system, or any combination thereof.

The first communication unit 1410 can include active or passive components, such as microelectronics or an antenna, for interaction with the communication path 106. The first control unit 1406 can execute the first software 1414 and can provide the intelligence of the first device 1402 for interaction with the second device 1404, the first user interface 1412, the communication path 106 via the first communication unit 1410, and interaction to the location unit 1304.

The second device 1404 can include, for example, a second control unit 1416, such as a processor or computer, a second storage unit 1418, a second user interface 1420, and a second communication unit 1422. For illustrative purposes, the navigation system 1400 is shown with the second device 1404 described with discrete functional modules, although it is understood that the navigation system 1400 can have the second device 1404 in a different configuration. For example, the second control unit 1416 and the second communication unit 1422 may not be discrete functional modules, but may have one or more of the aforementioned modules combined into one functional module.

The second storage unit 1418 can include second software 1424 of the second device 1404, the source map data 1006, and the compressed map data 1002. As an example, the second software 1424 can include a portion of the navigation system 200 of FIG. 2. For illustrative purposes, the second storage unit 1418 is shown as a single element, although it is understood that the second storage unit 1418 can be a distribution of storage elements.

Also for illustrative purposes, the navigation system 1400 is shown with the second storage unit 1418 as a single hierarchy storage system, although it is understood that the navigation system 1400 can have the second storage unit 1418 in a different configuration. For example, the second storage unit 1418 can be formed with different storage technologies forming a memory hierarchal system including different levels of caching, main memory, rotating media, or off-line storage.

The first communication unit 1410 can couple with the communication path 106 to send information to the second device 1404. The second device 1404 can receive information from the communication path 106 in the second communication unit 1422. The second communication unit 1422 can couple with the communication path 106 to send information to the first device 1402. The first device 1402 can receive information from the communication path 106 in the first communication unit 1410. The navigation system 1400 can be executed by the first control unit 1406, the second control unit 1416, or a combination thereof.

The second control unit 1416 can include the preconstruction module 1314. The preconstruction module 1314 can operate the second user interface 1420 to receive the source map data 1006. The preconstruction module 1314 can operate the map data compression flow 1000 of FIG. 10 to receive the source map data 1006 and to generate the compressed map data 1002. The preconstruction module 1314 can also operate the second user interface 1420 to receive the error correction 1020 of FIG. 10 for the purpose of updating the compressed map data 1002.

The second control unit 1416 can operate the second communication unit 1422 to send the compressed map data 1002 over the communication path 106 to the first device 1402. The second control unit 1416 can also store the compressed map data 1002 in the second storage unit 1418.

The first control unit 1406 can operate the first communication unit 1410 to receive the compressed map data 1002 from the communication path 106. The first control unit 1406 can store the compressed map data 1002 in the first storage unit 1408.

The first user interface 1412 can receive the starting location 1104 of FIG. 11 and the destination location 1106 of FIG. 11 in the route request module 1102 of FIG. 11. The first control unit 1406 can operate the location unit 1304 to receive a location reading if the starting location 1104 is a location reading of the first device 1402. The first control unit 1406 can also operate the route generation flow 1100 of the first software 1414 to generate the primary route 208 of FIG. 2. The first control unit 1406 can also operate the first user interface 1412 to display the primary route 208 on a display component of the first user interface 1412.

The first user interface 1412 can also receive the revised restriction 1018 of FIG. 10 and the error correction 1020 of FIG. 10. The first control unit 1406 can operate the customize data module 1016 of FIG. 10 to update the compressed map data 1002 on the first device 1402. The first control unit 1406 can also operate the shape selection 1200 to display the first feature 224 of FIG. 2 on a display of the first user interface 1412.

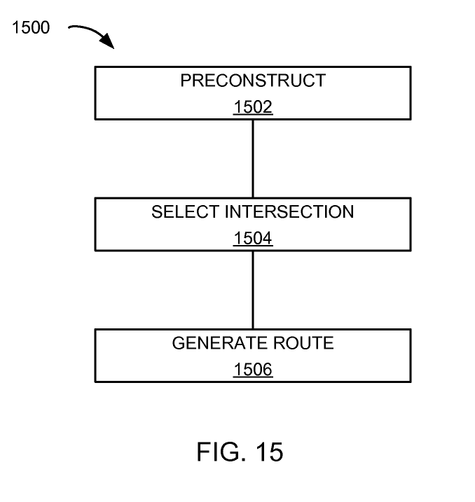

Referring now to FIG. 15, therein is shown a flow chart of a method 1500 of operation of the navigation system 200 with map compression in a further embodiment of the present invention. The method 1500 includes: preconstructing a multi-layered index based on a plurality of a spatially-aware identification for identifying location data points in a module 1502; selecting a first intersection based on the multi-layered index of the spatially-aware identification in a module 1504; and generating a primary route based on the first intersection for displaying on a device in a module 1506.

Yet another important aspect of the present invention is that it valuably supports and services the historical trend of reducing costs, simplifying systems, and increasing performance. These and other valuable aspects of the present invention consequently further the state of the technology to at least the next level.

Thus, it has been discovered that the navigation system of the present invention furnishes important and heretofore unknown and unavailable solutions, capabilities, and functional aspects for improving performance, increasing reliability, increasing safety and reducing cost of using a mobile client having location based services capability. The resulting processes and configurations are straightforward, cost-effective, uncomplicated, highly versatile, accurate, sensitive, and effective, and can be implemented by adapting known components for ready, efficient, and economical manufacturing, application, and utilization.

While the invention has been described in conjunction with a specific best mode, it is to be understood that many alternatives, modifications, and variations can be apparent to those skilled in the art in light of the aforegoing description. Accordingly, it is intended to embrace all such alternatives, modifications, and variations that fall within the scope of the included claims. All matters hithertofore set forth herein or shown in the accompanying drawings are to be interpreted in an illustrative and non-limiting sense.

What is claimed is:

1. A method of operation of a navigation system comprising:
preconstructing a multi-layered index based on a plurality of a spatially-aware identification for identifying location data points;
selecting a first intersection based on the multi-layered index of the spatially-aware identification; and
generating a primary route based on the first intersection for displaying on a device.

2. The method as claimed in claim 1 wherein preconstructing the multi-layered index includes:
providing an intersection record with a vint, an intersection relative location, a relative destination, and a relative origin; and
preconstructing topology data having the intersection record.

3. The method as claimed in claim 1 wherein selecting the first intersection includes:
traversing the multi-layered index to a first intersection record associated with the first intersection;
traversing the multi-layered index to a first relative destination associated with a second intersection; and
updating the primary route with a first road segment associated with the first intersection.

4. The method as claimed in claim 1 wherein generating the primary route includes:
retrieving a first time attribute associated with the first intersection; and
selecting a first road segment based on the first time attribute.

5. The method as claimed in claim 1 wherein generating the primary route includes:
retrieving a first length attribute associated with the first intersection; and
selecting a first road segment based on the first length attribute.

6. A method of operation of a navigation system comprising:
preconstructing a multi-layered index based on a plurality of a spatially-aware identification for identifying location data points;
submitting a revised restriction to a first intersection record;
selecting a first intersection based on the multi-layered index of the spatially-aware identification;
generating a primary route based on the first intersection with the revised restriction for displaying on a device; and
locating a first feature record associated with a first feature for displaying on the device.

7. The method as in claim 6 wherein preconstructing the multi-layered index includes preconstructing shape data including the first feature record associated with the first feature.

8. The method as claimed in claim 6 wherein locating the first feature record includes:
traversing the multi-layered index to a relative leaf identification; and
displaying the first feature based on a first zoom level of the first feature record.

9. The method as claimed in claim 6 wherein generating the primary route includes generating the primary route without the second intersection based on the revised restriction.

10. The method as claimed in claim 6 wherein selecting the first feature record includes displaying the first feature on the device based on a shape filter.

11. A navigation system comprising:
a preconstruction module for preconstructing a multi-layered index based on a plurality of a spatially-aware identification for identifying location data points;
a segment selection module for selecting a first intersection based on the multi-layered index of the spatially-aware identification; and
a navigation guidance module of a control unit for generating a primary route based on the first intersection for displaying on a device, the control unit coupled to a user interface.

12. The system as claimed in claim 11 wherein the preconstruction module is for providing an intersection record with a vint, an intersection relative location, a relative destination, and a relative origin, and preconstructing topology data having the intersection record.

13. The system as claimed in claim 11 wherein:
the segment selection module is for traversing the multi-layered index to a first intersection record associated with the first intersection, and traversing the multi-layered index to a first relative destination associated with a second intersection; and
the navigation guidance module of the control unit is for updating the primary route with a first road segment associated with the first intersection, the control unit coupled to a communication unit.

14. The system as claimed in claim 11 wherein the segment selection module is for retrieving a first time attribute associated with the first intersection and selecting a first road segment based on the first time attribute.

15. The system as claimed in claim 11 wherein the segment selection module is for retrieving a first length attribute associated with the first intersection and selecting a first road segment based on the first length attribute.

16. The system as claimed in claim 11 wherein:
the preconstruction module is for submitting a revised restriction to a first intersection record;
the navigation guidance module coupled to a communication unit and the user interface is for generating a primary route based on the first intersection with the revised restriction for displaying on a device; and
a map rendering module is for locating a first feature record associated with a first feature for displaying on the device.

17. The system as claimed in claim 16 wherein the preconstruction module is for preconstructing shape data including the first feature record associated with the first feature.

18. The system as claimed in claim 16 wherein:
the segment selection module is for traversing the multi-layered index to a relative leaf identification; and
the user interface is for displaying the first feature based on a first zoom level of the first feature record.

19. The system as claimed in claim 16 wherein the navigation guidance module is for generating the primary route without the second intersection based on the revised restriction.

20. The system as claimed in claim 16 wherein the map rendering module of the control unit is for displaying the first feature on the device based on a shape filter, the control unit coupled to the communication unit and the user interface.
